(19) United States
(12) Patent Application Publication
(10) Pub. No.: US 2026/0326730 A1
(43) Pub. Date: Oct. 22, 2026

(54) BRAKE SYSTEM

(71) Applicant: ADVICS CO., LTD., Kariya-shi, Aichi-ken (JP)

(72) Inventors: Kento HASHIMOTO, Kariya-shi, Aichi-ken (JP); Takuto KAWAI, Kariya-shi, Aichi-ken (JP); Hikaru KONDO, Kariya-shi, Aichi-ken (JP)

(73) Assignee: ADVICS CO., LTD., Kariya-shi, Aichi-ken (JP)

(21) Appl. No.: 19/122,097

(22) PCT Filed: Oct. 25, 2023
(86) PCT No.: PCT/JP2023/038524

§ 371 Date: Apr. 17, 2025

(30) Foreign Application Priority Data
Oct. 27, 2022 (JP) 2022-172465

(51) Int. Cl. B60T 8/88; B60T 17/18

(52) U.S. Cl. CPC B60T 8/885; B60T 17/18; B60T 2270/402; B60T 2270/404; B60T 2270/413; B60T 2270/82

(57) ABSTRACT

A brake system includes plural master controllers and plural slave controllers to. The master controller, the slave controller, and the slave controller are supplied with power from a first power source. The master controller, the slave controller, and the slave controller are supplied with the power from a second power source. The master controller and the slave controller can control the electric brake, the master controller and the slave controller can control the electric brake, the slave controller an control the electric brake, and the slave controller can control the electric brake.

### TECHNICAL FIELD

The present disclosure relates to a brake system that is applied to a vehicle.

### BACKGROUND ART

PTL 1 discloses an example of an in-vehicle system that includes a vehicle motion integrated control ECU and four BBW driver ECUs. The vehicle motion integrated control ECU calculates a command value of a braking force to be generated on each of plural wheels during braking of a vehicle. The vehicle motion integrated control ECU outputs the calculated command value to the plural BBW driver ECUs. Each of the BBW driver ECUs controls an electric motor on the basis of the input command value, and thereby adjusts the braking force to be generated on the corresponding wheel.

### CITATION LIST

### Patent Literature

PTL 1: Japanese Patent No. 6214730

### SUMMARY

### Technical Problem

When two power sources are provided in the vehicle, a first power source of the two power sources can supply power to one or more of the four BBW driver ECUs, and a second power source can supply power to the rest of the four BBW driver ECUS. An object of the disclosure is to suppress a reduction in a braking force of a vehicle when power supply from one of two power sources is stopped in a brake system capable of supplying the power from the two power sources.

### Solution to Problem

A brake system for solving the above problem is a system that is applied to a vehicle including a first power source and a second power source that differs from the first power source. The brake system includes: a first electric actuator to a fourth electric actuator that respectively generate a braking force on a first wheel to a fourth wheel of the vehicle; plural master controllers, each of which includes a driver that adjusts power supplied to any one of the first electric actuator to the fourth electric actuator, a braking force calculation section that calculates the braking force to be generated on the first wheel to the fourth wheel by driving of the first electric actuator to the fourth electric actuator, and a driver control section that actuates the driver according to a calculation result by the braking force calculation section; and plural slave controllers, each of which includes a driver that adjusts the power supplied to any one of the first electric actuator to the fourth electric actuator, and a driver control section that actuates the driver according to the calculation result by the braking force calculation section of the master controller. A first master controller of the plural master controllers and a first slave controller and a second slave controller of the plural slave controllers constitute a first controller group that is not supplied with the power from the second power source but is supplied with the power from the first power source. A second master controller of the plural master controllers and a third slave controller and a fourth slave controller of the plural slave controllers constitute a second controller group that is not supplied with the power from the first power source but is supplied with the power from the second power source. Both of a first regulation controller of the first controller group and a second regulation controller of the second controller group control the first electric actuator. Both of a third regulation controller, which differs from the first regulation controller, of the first controller group and a fourth regulation controller, which differs from the second regulation controller, of the second controller group control the second electric actuator. Of the first controller group, a controller that differs from the first regulation controller and the third regulation controller controls the third electric actuator. Of the second controller group, a controller that differs from the second regulation controller and the fourth regulation controller controls the fourth electric actuator.

In the brake system, when the power supply from the first power source is stopped, but the power is supplied from the second power source, the plural controllers that constitute the second controller group can be operated by the power supplied from the second power source. Accordingly, the braking force can be generated on three wheels of the four wheels. On the contrary, when the power supply from the second power source is stopped, but the power is supplied from the first power source, the plural controllers that constitute the first controller group can be operated by the power supplied from the first power source. Accordingly, the braking force can be generated on three wheels of the four wheels.

Therefore, according to the brake system, it is possible to suppress a reduction in the braking force when the power supply from one of the first power source and the second power source is stopped.

### BRIEF DESCRIPTION OF DRAWINGS

FIG. 1 is a configuration view that schematically illustrates a vehicle to which a brake system according to an embodiment is applied.

FIG. 2 is a block diagram illustrating a configuration of the brake system.

FIG. 3 is a table illustrating a relationship between a master controller, which calculates a commanded braking force to be adopted, and a driver to be actuated when a braking controller of the brake system can be actuated normally.

FIG. 4 is a table illustrating a relationship between the master controller, which calculates the commanded braking force to be adopted, and the driver to be actuated when power supply from one of a first power source and a second power source is stopped.

FIG. 5 is a table illustrating a relationship between the master controller, which calculates the commanded braking force to be adopted, and the driver to be actuated when one of the two master controllers has failed.

FIG. 6 is a flowchart illustrating a series of processing that is executed by the master controller.

FIG. 7 is a flowchart illustrating a series of processing that is executed by a slave controller.

FIG. 8 is a block diagram illustrating a configuration of a brake system in a modified example.

### DESCRIPTION OF EMBODIMENTS

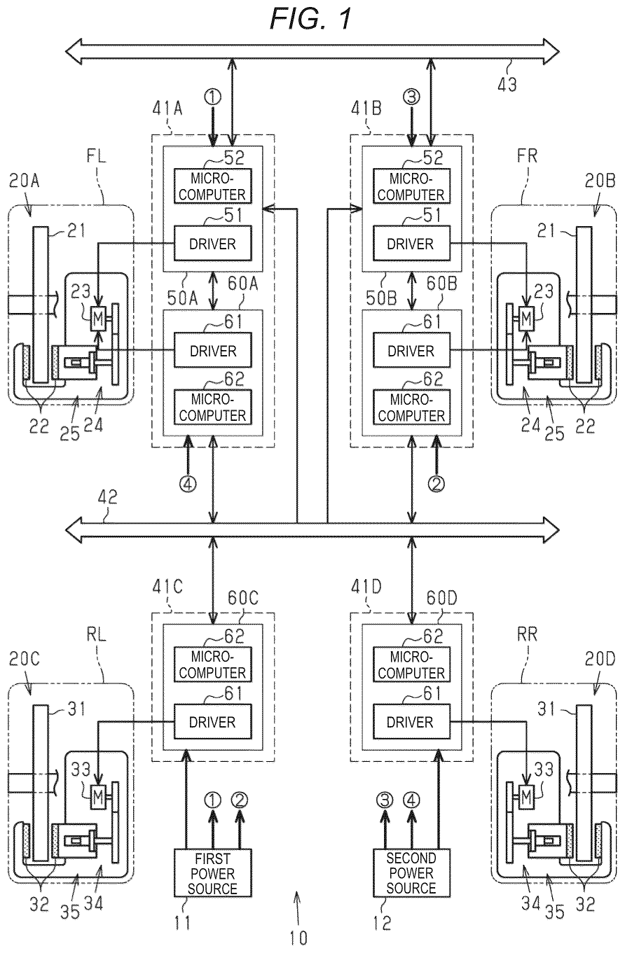

A description will hereinafter be made on an embodiment of a brake system with reference to FIG. 1 to FIG. 7.

### Schematic Configuration of Vehicle

FIG. 1 illustrates a vehicle 10, to which the brake system is applied. The vehicle 10 includes, as wheels, a left front wheel FL, a right front wheel FR, a left rear wheel RL, and a right rear wheel RR. The vehicle 10 includes a first power source 11 and a second power source 12 that differs from the first power source 11 as power supply sources to the brake system.

### Electric Brakes of Brake System

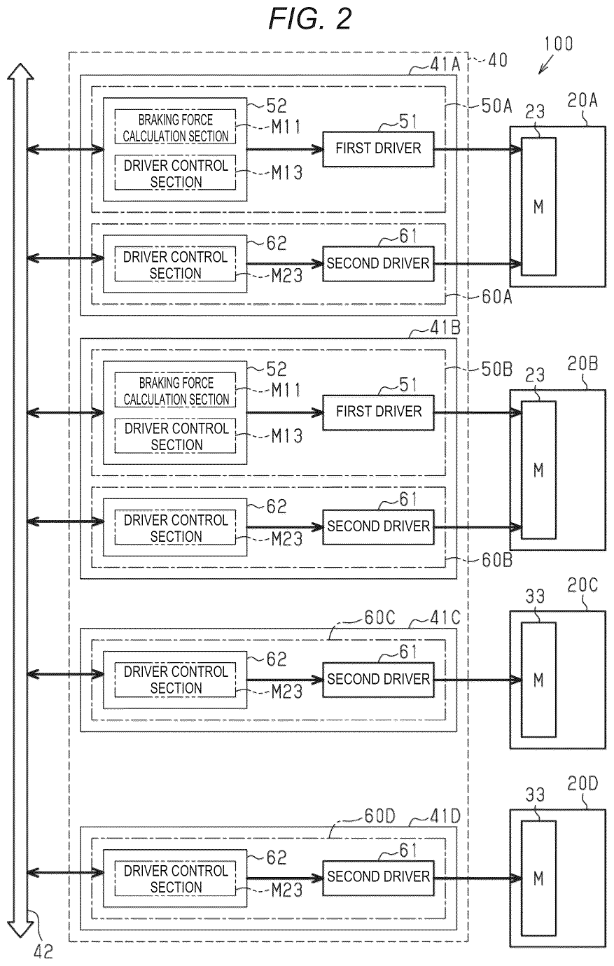

As illustrated in FIG. 1 and FIG. 2, a brake system 100 includes four electric brakes. The four electric brakes correspond to the four wheels FL, FR, RL, RR, respectively. More specifically, the four electric brakes are: an electric brake 20A that generates a braking force on the left front wheel FL; an electric brake 20B that generates the braking force on the right front wheel FR; an electric brake 20C that generates the braking force on the left rear wheel RL; and an electric brake 20D that generates the braking force on the right rear wheel RR. Hereinafter, the electric brakes 20A, 20B for the front wheels will also be referred to as “front-wheel electric brakes 20A, 20B”, and the electric brakes 20C, 20D for the rear wheels will also be referred to as “rear-wheel electric brakes 20C, 20D”.

Each of the plural front-wheel electric brakes 20A, 20B includes a rotating body 21, a friction member 22, an electric motor 23, a speed reduction mechanism 24, and a linear motion conversion mechanism 25. The rotating body 21 rotates integrally with respective one of the front wheels FL, FR. In each of the front-wheel electric brakes 20A, 20B, rotary motion of the electric motor 23 is decelerated by the speed reduction mechanism 24 and is then output to the linear motion conversion mechanism 25. Then, the rotary motion that has been input to the linear motion conversion mechanism 25 is converted into linear motion by the linear motion conversion mechanism 25 and is then output to the friction member 22. That is, each of the front-wheel electric brakes 20A, 20B adjusts the braking force to be generated on respective one of the front wheels FL, FR by controlling the electric motor 23. The electric motor 23 is a double-winding motor.

Each of the plural rear-wheel electric brakes 20C, 20D includes a rotating body 31, a friction member 32, an electric motor 33, a speed reduction mechanism 34, and a linear motion conversion mechanism 35. The rotating body 31 rotates integrally with respective one of the rear wheels RL, RR. In each of the electric brakes 20C, 20D, rotary motion of the electric motor 33 is decelerated by the speed reduction mechanism 34 and is then output to the linear motion conversion mechanism 35. Then, the rotary motion that has been input to the linear motion conversion mechanism 35 is converted into linear motion by the linear motion conversion mechanism 35 and is then output to the friction member 32. That is, each of the rear-wheel electric brakes 20C, 20D adjusts the braking force to be generated on respective one of the rear wheels RL, RR by controlling the electric motor 33. Unlike the electric motor 23, the electric motor 33 is not a double-winding motor.

In this embodiment, the electric motors 23, 33 of the plural electric brakes 20A to 20D each correspond to an “electric actuator”. In particular, the electric motor 23 of the electric brake 20A for the left front wheel corresponds to a “first electric actuator”, and the electric motor 23 of the electric brake 20B for the right front wheel corresponds to a “second electric actuator”. The electric motor 33 of the electric brake 20C for the left rear wheel corresponds to a “third electric actuator”, and the electric motor 33 of the electric brake 20D for the right rear wheel corresponds to a “fourth electric actuator”. Here, the left front wheel FL, on which the braking force is generated by driving of the first electric actuator, will also be referred to as a “first wheel”. The right front wheel FR, on which the braking force is generated by driving of the second electric actuator, will also be referred to as a “second wheel”. The left rear wheel RL, on which the braking force is generated by driving of the third electric actuator, will also be referred to as a “third wheel”. The right rear wheel RR, on which the braking force is generated by driving of the fourth electric actuator, will also be referred to as a “fourth wheel”.

### Braking Controller in Brake System

The brake system 100 includes a braking controller 40 that controls the four electric brakes 20A to 20D. The braking controller 40 has a left front wheel control unit 41A, a right front wheel control unit 41B, a left rear wheel control unit 41C, and a right rear wheel control unit 41D. The left front wheel control unit 41A controls the electric brake 20A for the left front wheel. The right front wheel control unit 41B controls the electric brake 20B for the right front wheel. The left rear wheel control unit 41C controls the electric brake 200 for the left rear wheel. The right rear wheel control unit 41D controls the electric brake 20D for the right rear wheel. The plural control units 41A to 41D are each configured to be able to exchange information via intra-braking controller communication 42. For example, the intra-braking controller communication 42 is a CAN bus. “CAN” stands for a “controller area network”.

The left front wheel control unit 41A has a master controller 50A and a slave controller 60A. The master controller 50A and the slave controller 60A are configured to enable mutual exchange of the information within the left front wheel control unit 41A.

The right front wheel control unit 41B has a master controller 50B and a slave controller 60B. The master controller 50B and the slave controller 60B are configured to enable mutual exchange of the information within the right front wheel control unit 41B.

The left rear wheel control unit 41C has a slave controller 60C but does not have a master controller. The right rear wheel control unit 41D has a slave controller 60D but does not have a master controller.

The plural controllers 50A, 50B, 60A to 60D that constitute the brake system 100 can be classified into a first controller group, to which the power is supplied from the first power source 11, and a second controller group, to which the power is supplied from the second power source 12. The first controller group includes: the master controller 50A of the plural master controllers 50A, 50B; and the slave controller 60B and the slave controller 60C of the plural slave controllers 60A to 60D. Meanwhile, the second controller group includes: the master controller 50B of the plural master controllers 50A, 50B; and the slave controller 60A and the slave controller 60D of the plural slave controllers 60A to 60D. Here, the power is not supplied from the second power source 12 to the plural controllers 50A, 60B, 60C that constitute the first controller group. The power is not supplied from the first power source 11 to the plural controllers 50B, 60A, 60D that constitute the second controller group.

In this embodiment, the master controller 50A corresponds to a “first master controller”, and the master controller 50B corresponds to a “second master controller”. In addition, the slave controller 60B that constitutes the first controller group corresponds to a “first slave controller”, and the slave controller 60C that constitutes the first controller group corresponds to a “second slave controller”. Furthermore, the slave controller 60A that constitutes the second controller group corresponds to a “third slave controller”, and the slave controller 60D that constitutes the second controller group corresponds to a “fourth slave controller”.

Both the master controller 50A in the first controller group and the slave controller 60A in the second controller group control the first electric actuator. In this embodiment, since the electric motor 23 of the left front wheel control unit 41A corresponds to the first electric actuator, the master controller 50A corresponds to a “first regulation controller”, and the slave controller 60A corresponds to a “second regulation controller”. As described above, the electric motor 23 is the double-winding motor. Accordingly, the master controller 50A adjusts a current through a first wire of two wires of the electric motor 23, and the slave controller 60A adjusts a current through a second wire of the two wires of the electric motor 23. Thus, when at least one of the master controller 50A and the slave controller 60A is operated, the braking force to be generated on the left front wheel FL can be adjusted by driving the electric motor 23.

Both the master controller 50B in the second controller group and the slave controller 60B in the first controller group control the second electric actuator. In this embodiment, since the electric motor 23 of the right front wheel control unit 41B corresponds to the second electric actuator, the master controller 50B corresponds to a “fourth regulation controller”, and the slave controller 60B corresponds to a “third regulation controller”. As described above, the electric motor 23 is the double-winding motor. Accordingly, the master controller 50B adjusts a current through a first wire of two wires in the electric motor 23, and the slave controller 60B adjusts a current through a second wire of the two wires in the electric motor 23. Thus, when at least one of the master controller 50B and the slave controller 60B is operated, the braking force to be generated on the right front wheel FR can be adjusted by driving the electric motor 23.

In the first controller group, the slave controller 60C, which differs from the master controller 50A and the slave controller 60B, controls the third electric actuator. In this embodiment, since the electric motor 33 of the left rear wheel control unit 41C corresponds to the third electric actuator, the slave controller 60C can adjust the braking force to be generated on the left rear wheel RL by driving the electric motor 33 of the left rear wheel control unit 41C.

In the second controller group, the slave controller 60D, which differs from the master controller 50B and the slave controller 60A, controls the fourth electric actuator. In this embodiment, since the electric motor 33 of the right rear wheel control unit 41D corresponds to the fourth electric actuator, the slave controller 60D can adjust the braking force to be generated on the right rear wheel RR by driving the electric motor 33 of the right rear wheel control unit 41D.

The plural master controllers 50A, 50B each have a first driver 51 and a master microcomputer 52. The master microcomputer 52 includes an execution section and a storage section that stores a control program executed by the execution section. For example, the execution section is a CPU. Since the electric motor 23 is the double-winding motor, the first driver 51 is electrically connected only to the first wire of the two wires of the electric motor 23. The execution section of the master microcomputer 52 actuates the first driver 51 by executing the control program. Consequently, the execution section adjusts the current through the first wire of the electric motor 23, and can thereby drive the electric motor 23.

The plural slave controllers 60A to 60D each have a second driver 61 and a slave microcomputer 62. The slave microcomputer 62 includes an execution section and a storage section that stores a control program executed by the execution section. For example, the execution section is a CPU. Since the electric motor 23 is the double-winding motor, the second driver 61 is electrically connected only to the second wire of the two wires of the electric motor 23. The execution section of the slave microcomputer 62 in each of the slave controllers 60A, 60B actuates the second driver 61 by executing the control program. Consequently, the execution section adjusts the current through the second wire of the electric motor 23, and can thereby drive the electric motor 23.

The execution section of the slave microcomputer 62 in each of the slave controllers 60C, 60D actuates the second driver 61 by executing the control program. Consequently, the execution section adjusts the current through the wire of the electric motor 33, and can thereby drive the electric motor 33.

Here, the plural master microcomputers 52 each communicate with a device other than the brake system 100 via an in-vehicle network 43, the device being mounted on the vehicle. Meanwhile, the plural slave microcomputers 62 are not connected to the in-vehicle network 43. For example, the in-vehicle network 43 is a CAN bus. While the master microcomputer 52 is connected to the in-vehicle network 43, the slave microcomputer 62 is not connected to the in-vehicle network 43. Thus, there is no need to make the slave microcomputer 62 a security-compliant microcomputer. As a result, the brake system 100 can be constructed at low cost. The slave microcomputer 62 exchanges the information only within the brake system 100 by using the intra-braking controller communication 42.

In the brake system 100, the left front wheel control unit 41A and the electric brake 20A are unitized to constitute a brake unit for the left front wheel. The right front wheel control unit 41B and the electric brake 20B are unitized to constitute a brake unit for the right front wheel. The left rear wheel control unit 41C and the electric brake 20C are unitized to constitute a brake unit for the left rear wheel. The right rear wheel control unit 41D and the electric brake 20D are unitized to constitute a brake unit for the right rear wheel.

### Functional Configurations of Controllers

A description will be made on functional configurations of controllers with reference to FIG. 2.

The execution sections of the plural master controllers 50A, 50B each function as a braking force calculation section M11 and a driver control section M13 by executing the control program. Each of the braking force calculation section M11 and the driver control section M13 is a functional section for driving the electric motor.

The braking force calculation section M11 calculates the braking force to be generated on the wheel by driving of the electric motor of the electric brake. For example, based on a requested value of deceleration of the vehicle 10, the braking force calculation section M11 calculates a commanded braking force for each of the wheels FL, FR, RL, RR, the commanded braking force being a command value of the braking force to be generated on the wheel. In other words, the braking force calculation section M11 calculates a commanded braking force FbA for the left front wheel FL, a commanded braking force FbB for the right front wheel FR, a commanded braking force FbC for the left rear wheel RL, and a commanded braking force FbD for the right rear wheel RR.

The driver control section M13 adjusts the power supplied to the electric motor 23 of the front-wheel electric brake by actuating the first driver 51 according to a calculation result by the braking force calculation section M11. More specifically, the driver control section M13 of the left front wheel control unit 41A actuates the first driver 51 on the basis of the commanded braking force FbA on the left front wheel FL, and thereby adjusts the power supplied to the electric motor 23 of the electric brake 20A for the left front wheel. The driver control section M13 of the right front wheel control unit 41B actuates the first driver 51 on the basis of the commanded braking force FbB on the right front wheel FR, and thereby adjusts the power supplied to the electric motor 23 of the electric brake 20B for the right front wheel.

The execution sections of the plural slave controllers 60A to 60D each function as a driver control section M23 by executing the control program. The driver control section M23 is a functional section for driving the electric motor. The execution section of each of the slave controllers 60A to 60D does not function as a braking force calculation section.

The driver control sections M23 of the slave controllers 60A, 60B for the front wheels each adjust the power supplied to the electric motor 23 of the front-wheel electric brake by actuating the second driver 61 according to the calculation result by the braking force calculation section M11. More specifically, the driver control section M23 of the left front wheel control unit 41A actuates the second driver 61 on the basis of the commanded braking force FbA on the left front wheel FL, and thereby adjusts the power supplied to the electric motor 23 of the electric brake 20A for the left front wheel. The driver control section M23 of the right front wheel control unit 41B actuates the second driver 61 on the basis of the commanded braking force FbB on the right front wheel FR, and thereby adjusts the power supplied to the electric motor 23 of the electric brake 20B for the right front wheel.

Driver control sections M23 of the slave controllers 60C, 60D for the rear wheels each adjust the power supplied to the electric motor 33 of the rear-wheel electric brake by actuating the second driver 61 according to the calculation result by the braking force calculation section M11. More specifically, the driver control section M23 of the left rear wheel control unit 41C actuates the second driver 61 on the basis of the commanded braking force FbC on the left rear wheel RL, and thereby adjusts the power Supplied to the electric motor 33 of the electric brake 20C for the left rear wheel. The driver control section M23 of the right rear wheel control unit 41D actuates the second driver 61 on the basis of the commanded braking force FbD on the right rear wheel RR, and thereby adjusts the power supplied to the electric motor 33 of the electric brake 20D for the right rear wheel.

### Braking Control in Normal Time

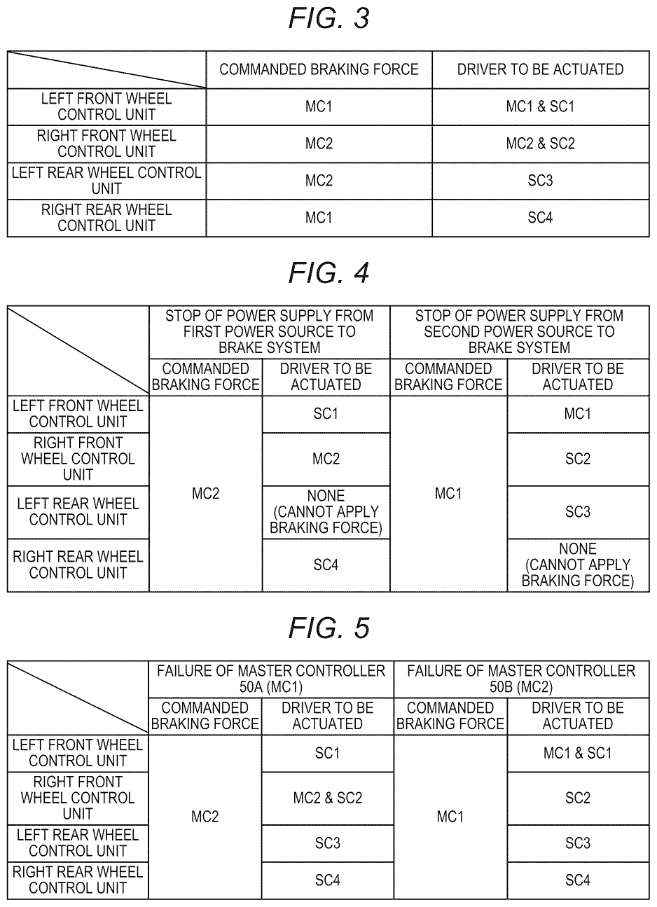

A description will be made on braking control in a normal time with reference to FIG. 3. “Normal” described herein refers to a state of the braking controller 40 where the power is supplied to the brake system 100 from both the first power source 11 and the second power source 12, and where each of the plural master controllers 50A, 50B is operated normally. In FIG. 3 to FIG. 5, “MC1” indicates the master controller 50A, and “MC2” indicates the master controller 50B. In addition, “SC1” indicates the slave controller 60A, “SC2” indicates the slave controller 60B, “SC3” indicates the slave controller 60C, and “SC4” indicates the slave controller 60D.

The left front wheel control unit 41A is actuated on the basis of the commanded braking force FbA that is calculated by the braking force calculation section M11 of the master controller 50A. That is, the driver control section M13 of the master controller 50A actuates the first driver 51 on the basis of the commanded braking force FbA that is calculated by the braking force calculation section M11 of the master controller 50A. Meanwhile, the driver control section M23 of the slave controller 60A actuates the second driver 61 on the basis of the commanded braking force FbA that is calculated by the braking force calculation section M11 of the master controller 50A.

In the following description, the commanded braking force that is calculated by the braking force calculation section M11 of the master controller 50A will be referred to as the “commanded braking force that is calculated by the master controller 50A”. In addition, the commanded braking force that is calculated by the braking force calculation section M11 of the master controller 50B will be referred to as the “commanded braking force that is calculated by the master controller 50B”.

The right front wheel control unit 41B is actuated on the basis of the commanded braking force FbB that is calculated by the master controller 50B. That is, the driver control section M13 of the master controller 50B actuates the first driver 51 on the basis of the commanded braking force FbB that is calculated by the master controller 50B. In addition, the driver control section M23 of the slave controller 60B actuates the second driver 61 on the basis of the commanded braking force FbB that is calculated by the master controller 50B.

The left rear wheel control unit 41C is actuated on the basis of the commanded braking force FbC that is calculated by the master controller 50B. That is, the driver control section M23 of the slave controller 60C actuates the second driver 61 on the basis of the commanded braking force FbC that is calculated by the master controller 50B.

The right rear wheel control unit 41D is actuated on the basis of the commanded braking force FbD that is calculated by the master controller 50A. That is, the driver control section M23 of the slave controller 60D actuates the second driver 61 on the basis of the commanded braking force FbD that is calculated by the master controller 50A.

### Braking Control When Power Supply from Power Source to Brake System is Stopped

A description will hereinafter be made on the braking control in the case where the power is supplied from one of the first power source 11 and the second power source 12 to the brake system 100, but the power supply from the other thereof to the brake system 100 is stopped.

First, a description will be made on a case where the power supply from the first power source 11 to the brake system 100 is stopped. In this case, the controllers 50A, 60B, 60C that constitute the first controller group are not operated.

The left front wheel control unit 41A is actuated on the basis s of the commanded braking force FbA that is calculated by the master controller 50B. That is, the driver control section M23 of the slave controller 60A actuates the second driver 61 on the basis of the commanded braking force FbA that is calculated by the master controller 50B.

The right front wheel control unit 41B is actuated on the basis of the commanded braking force FbB that is calculated by the master controller 50B. That is, the driver control section M13 of the master controller 50B actuates the first driver 51 on the basis of the commanded braking force FbB that is calculated by the master controller 50B.

When the power supply to the slave controller 600 is stopped, the second driver 61 of the slave controller 600 is not actuated. Consequently, the left rear wheel control unit 41C is not actuated. Thus, the slave controller 60C cannot adjust the braking force to be generated on the left rear wheel RL.

The right rear wheel control unit 41D is actuated on the basis of the commanded braking force FbD that is calculated by the master controller 50B. That is, the driver control section M23 of the slave controller 60D actuates the second driver 61 on the basis of the commanded braking force FbD that is calculated by the master controller 50B.

A description will be made on an opposite case where the power supply from the second power source 12 to the brake system 100 is stopped. In this case, the controllers 50B, 60A, 60D that constitute the second controller group are not operated.

The left front wheel control unit 41A is actuated on the basis of the commanded braking force FbA that is calculated by the master controller 50A. That is, the driver control section M13 of the master controller 50A actuates the first driver 51 on the basis of the commanded braking force FbA that is calculated by the master controller 50A.

The right front wheel control unit 41B is actuated on the basis of the commanded braking force FbB that is calculated by the master controller 50A. That is, the driver control section M23 of the slave controller 60B actuates the second driver 61 on the basis of the commanded braking force FbB that is calculated by the master controller 50A.

The left rear wheel control unit 41C is actuated on the basis of the commanded braking force FbC that is calculated by the master controller 50A. That is, the driver control section M23 of the slave controller 60C actuates the second driver 61 on the basis of the commanded braking force FbC that is calculated by the master controller 50A.

When the power supply to the slave controller 60D is stopped, the second driver 61 of the slave controller 60D is not actuated. Consequently, the right rear wheel control unit 41D is not actuated. Thus, the slave controller 60D cannot adjust the braking force to be generated on the right rear wheel RR.

### Braking Control When Master Controller Fails

A description will be made on the braking control when one of the plural master controllers 50A, 50B is operated normally but the other fails with reference to FIG. 5. Herein, a description will be made on assumption that the power is supplied to the brake system 100 from both the first power source 11 and the second power source 12.

First, a description will be made on a case where the master controller 50A fails.

The left front wheel control unit 41A is actuated on the basis of the commanded braking force FbA that is calculated by the master controller 50B. That is, the slave controller 60A actuates the second driver 61 on the basis of the commanded braking force FbA that is calculated by the master controller 50B. At this time, since the master controller 50A has failed, the first driver 51 of the left front wheel control unit 41A cannot be actuated.

The right front wheel control unit 41B is actuated on the basis of the commanded braking force FbB that is calculated by the master controller 50B. That is, the driver control section M13 of the master controller 50B actuates the first driver 51 on the basis of the commanded braking force FbB that is calculated by the master controller 50B. In addition, the driver control section M23 of the slave controller 60B actuates the second driver 61 on the basis of the commanded braking force FbB that is calculated by the master controller 50B.

The left rear wheel control unit 41C is actuated on the basis of the commanded braking force FbC that is calculated by the master controller 50B. That is, the driver control section M23 of the slave controller 60C actuates the second driver 61 on the basis of the commanded braking force FbC that is calculated by the master controller 50B.

The right rear wheel control unit 41D is actuated on the basis of the commanded braking force FbD that is calculated by the master controller 50B. That is, the driver control section M23 of the slave controller 60D actuates the second driver 61 on the basis of the commanded braking force FbD that is calculated by the master controller 50B.

Next, a description will be made on a case where the master controller 50B fails.

The left front wheel control unit 41A is actuated on the basis of the commanded braking force FbA that is calculated by the master controller 50A. That is, the driver control section M13 of the master controller 50A actuates the first driver 51 on the basis of the commanded braking force FbA that is calculated by the master controller 50A. In addition, the driver control section M23 of the slave controller 60A actuates the second driver 61 on the basis of the commanded braking force FbA that is calculated by the master controller 50A.

The right front wheel control unit 41B is actuated on the basis of the commanded braking force FbB that is calculated by the master controller 50A. That is, the slave controller 60B actuates the second driver 61 on the basis of the commanded braking force FbB that is calculated by the master controller 50A. At this time, since the master controller 50B has failed, the first driver 51 of the right front wheel control unit 41B cannot be actuated.

The left rear wheel control unit 41C is actuated on the basis of the commanded braking force FbC that is calculated by the master controller 50A. That is, the driver control section M23 of the slave controller 60C actuates the second driver 61 on the basis of the commanded braking force FbC that is calculated by the master controller 50A.

The right rear wheel control unit 41D is actuated on the basis of the commanded braking force FbD that is calculated by the master controller 50A. That is, the driver control section M23 of the slave controller 60D actuates the second driver 61 on the basis of the commanded braking force FbD that is calculated by the master controller 50A.

### Processing Procedure Executed By Master Microcomputer of Master Controller

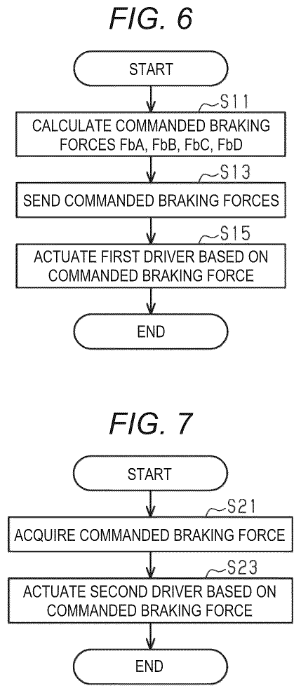

A description will be made on master-side processing, which is a series of processing executed by the master microcomputers 52 of the master controllers 50A, 50B, with reference to FIG. 6. The master microcomputer 52 repeatedly executes the master-side processing in every predetermined control cycle.

In step S11, the master microcomputer 52 functions as the braking force calculation section M11 and thereby calculates the commanded braking forces FbA to FbD for the plural wheels FL, FR, RL, RR. That is, each of the master microcomputer 52 of master controller 50A and the master microcomputer 52 of the master controller 50B calculates the commanded braking forces FbA to FbD for the plural wheels FL, FR, RL, RR.

In step S13, the master microcomputer 52 sends the commanded braking forces, which have been calculated in step S11. More specifically, the master microcomputer 52 of the master controller 50A sends, to the intra-braking controller communication 42, the commanded braking forces FbB, FbC, FbD for the wheels FR, RL, RR other than the left front wheel FL. In addition, the master microcomputer 52 of the master controller 50A sends the commanded braking force FbA for the left front wheel FL to the slave controller 60A. Meanwhile, the master microcomputer 52 of the master controller 50B sends, to the intra-braking controller communication 42, the commanded braking forces FbA, FbC, FbD for the wheels FL, RL, RR other than the right front wheel FR. In addition, the master microcomputer 52 of the master controller 50B sends the commanded braking force FbB for the right front wheel FR to the slave controller 60B.

In step S15, the master microcomputer 52 functions as the driver control section M13, and thereby actuates the first driver 51 on the basis of the commanded braking force. More specifically, the master microcomputer 52 of the master controller 50A actuates the first driver 51 of the electric brake 20A on the basis of the commanded braking force FbA for the left front wheel FL, which is calculated by itself. Meanwhile, the master microcomputer 52 of the master controller 50B actuates the first driver 51 of the electric brake 20B on the basis of the commanded braking force FbB for the right front wheel FR, which is calculated by itself. Thereafter, the master microcomputer 52 terminates the master-side processing once.

### Processing Procedure Executed by Slave Microcomputer of Slave Controller

A description will be made on slave-side processing, which is a series of processing executed by the slave microcomputers 62 of the slave controllers 60A to 60D, with reference to FIG. 7. The slave microcomputer 62 repeatedly executes the slave-side processing in every predetermined control cycle.

In step S21, the slave microcomputer 62 acquires the commanded braking force for actuating the second driver 61.

More specifically, when receiving the commanded braking force FbA from the master controller 50A, the slave microcomputer 62 of slave controller 60A in the left front wheel control unit 41A acquires the commanded braking force FbA that is calculated by the master controller 50A. In the case where the commanded braking force FbA cannot be received from the master controller 50A, but the commanded braking force FbA that is calculated by the master controller 50B can be received from the intra-braking controller communication 42, the slave microcomputer 62 of the slave controller 60A acquires the commanded braking force that is calculated by the master controller 50B.

When receiving the commanded braking force FbB from the master controller 50B, the slave microcomputer 62 of the slave controller 60B in the right front wheel control unit 41B acquires the commanded braking force FbB that is calculated by the master controller 50B. In the case where the commanded braking force FbB cannot be received from the master controller 50B, but the commanded braking force FbB that is calculated by the master controller 50A can be received from the intra-braking controller communication 42, the slave microcomputer 62 of the slave controller 60B acquires the commanded braking force FbB that is calculated by the master controller 50A.

In the case where the commanded braking force FbC that is calculated by the master controller 50B can be acquired from the intra-braking controller communication 42, the slave microcomputer 62 of the slave controller 60C in the left rear wheel control unit 41C acquires the commanded braking force FbC that is calculated by the master controller 50B. In the case where the commanded braking force FbC that is calculated by the master controller 50B cannot be received, but the commanded braking force FbC that is calculated by the master controller 50A can be received from the intra-braking controller communication 42, the slave microcomputer 62 of the slave controller 60C acquires the commanded braking force FbC that is calculated by the master controller 50A.

When the commanded braking force FbD that is calculated by the master controller 50A can be acquired from the intra-braking controller communication 42, the slave microcomputer 62 of the slave controller 60D in the right rear wheel control unit 41D acquires the commanded braking force FbD that is calculated by the master controller 50A. In the case where the commanded braking force FbD that is calculated by the master controller 50A cannot be received, but the commanded braking force FbD that is calculated by the master controller 50B can be received from the intra-braking controller communication 42, the slave microcomputer 62 of the slave controller 60D acquires the commanded braking force FbD that is calculated by the master controller 50B.

In step S23, the slave microcomputer 62 actuates the second driver 61 on the basis of the commanded braking force acquired in step S21. More specifically, the slave microcomputer 62 of the slave controller 60A in the left front wheel control unit 41A actuates the second driver 61 of the electric brake 20A on the basis of the commanded braking force FbA. The slave microcomputer 62 of the slave controller 60B in the right front wheel control unit 41B actuates the second driver 61 of the electric brake 20B on the basis of the commanded braking force FbB. The slave microcomputer 62 of the slave controller 60C in the left rear wheel control unit 41C actuates the second driver 61 of the electric brake 20C on the basis of the commanded braking force FbC. The slave microcomputer 62 of the slave controller 60D in the right rear wheel control unit 41D actuates the second driver 61 of the electric brake 20D on the basis of the commanded braking force FbD. Thereafter, the slave microcomputer 62 terminates the slave-side processing once.

### Operation and Effects of This Embodiment

(1) In the case where the power supply from the first power source 11 to the brake system 100 is stopped, but the power is supplied from the second power source 12 to the brake system 100, the controllers in the second controller group are operated. Accordingly, the braking force can be generated on three wheels of the four wheels FL, FR, RL, RR. On the contrary, in the case where the power supply from the second power source 12 to the brake system 100 is stopped, but the power is supplied from the first power source 11 to the brake system 100, the controllers in the first controller group are operated. Accordingly, the braking force can be generated on three wheels of the four wheels FL, FR, RL, RR. Therefore, the brake system 100 can suppress the reduction in the braking force of the vehicle 10 when the power supply from one of the first power source 11 and the second power source 12 is stopped.

In the case where the controllers in the first controller group can be operated while the controllers in the second controller group cannot be operated, the braking force can be generated on the wheels FL, FR, RL other than the right rear wheel RR. On the contrary, in the case where the controllers in the second controller group can be operated while the controllers in the first controller group cannot be operated, the braking force can be generated on the wheels FL, FR, RR other than the left rear wheel RL.

In addition, the first controller group is not supplied with the power from the second power source 12 but is supplied with the power from the first power source 11. The second controller group is not supplied with the power from the first power source 11 but is supplied with the power from the second power source 12. In this way, it is possible to prevent such a case where potentials of the first power source 11 and the second power source 12 are reduced simultaneously due to ground fault of the controllers in the first controller group or the controllers in the second controller group and thus the power can no longer be supplied to the brake system 100.

(2) A case where the electric motor 23 of the front wheel control unit only has the single wire is considered. In this case, in order to enable actuation of the driver of the electric motor 23 by any one of the master controller and the slave controller of the front wheel control unit, a switching circuit for switching the controller for controlling the driver between the master controller and the slave controller may be provided to the front wheel control unit. When the controller for controlling the driver is switched from one of the master controller and the slave controller to the other, the switching circuit has to be actuated, and the control of the electric motor 23 may be interrupted temporarily in the middle of switching.

In this regard, in the brake system 100, the electric motor 23 of the front wheel control unit is the double-winding motor. Of the two wires, the first wire is electrically connected to the first driver 51 of the master controller, and the second wire is electrically connected to the second driver 61 of the slave controller. Then, when both the master controller and the slave controller are operated, both the first driver 51 and the second driver 61 are actuated. Therefore, even when the operation of one of the master controller and the slave controller is stopped during driving of the electric motor 23, the control of the electric motor 23 can be continued. That is, it is possible to prevent the temporary interruption of the control of the electric motor 23.

(3) The electric motor 23 of the front wheel control unit is the double-winding motor, and the front wheel control unit includes both the master controller and the slave controller. Furthermore, one of the master controller and the slave controller constitutes the first controller group, and the other constitutes the second controller group. Accordingly, even when the power supply from one of the first power source 11 and the second power source 12 to the brake system 100 is stopped, the braking force can be generated on the plural front wheels FL, FR.

(4) The plural master controllers 50A, 50B each calculate the commanded braking forces FbA to FbD for the plural wheels FL, FR, RL, RR. Accordingly, even when only one of the plural master controllers 50A, 50B fails, each of the plural control units 41A to 41D can acquire the commanded braking force. Thus, each of the plural control units 41A to 41D can drive the respective electric motor. Therefore, even when only one of the plural master controllers 50A, 50B fails, the braking force can be generated on the plural wheels FL, FR, RL, RR.

(5) Unlike the master controllers 50A, 50B, the slave controllers 60A to 60D do not have the functions to calculate the commanded braking forces FbA to FbD, respectively. Thus, a microcomputer with lower functionality than the master microcomputer 52 of each of the master controllers 50A, 50B can be adopted as the slave microcomputer 62 of each of the slave controllers 60A to 60D. That is, the brake system 100 can suppress the reduction in the braking force of the vehicle 10 when the power supply from one of the two power sources 11, 12 is stopped while suppressing cost increase. The “microcontroller with the low functionality” described herein has a lower operating frequency and the smaller number of CPU cores than a microcomputer without low functionality.

(6) In this embodiment, since the electric brake 20A and the master controller 50A for the front wheel are unitized, the driver control section M13 and the first driver 51 are present near the electric motor 23. Operational effects exerted by this arrangement will be described below. Since the driver control section M13 is required to send the detailed command to the driver that actuates the electric motor 23, the driver control section M13 has to perform the calculation in a faster control cycle than that of the intra-braking controller communication 42. Thus, when the signal of the driver control section M13 is exchanged via the intra-braking controller communication 42, control accuracy of the electric motor 23 is possibly reduced. Meanwhile, the braking force calculation section M11 does not have to perform the calculation in the faster calculation cycle than the intra-braking controller communication 42. Thus, even when the signal of the braking force calculation section M11 is exchanged via the intra-braking controller communication 42, the control accuracy of the electric motor 23 is not reduced.

From what have been described so far, since the master controller 50A, which includes the braking force calculation section M11, the driver control section M13, and the first driver 51, and the electric brake 20A are unitized, the signal of the driver control section M13, which is provided to the master controller 50A, can be sent to the first driver 51 without being exchanged via the intra-braking controller communication 42. In addition, since the master controller 50A and the electric brake 20A have been unitized, the first driver 51 can directly supply the power to the electric motor 23 of the electric brake 20A. Thus, it is possible to constitute an inexpensive brake system that has a redundant configuration without increasing the number of the microcomputers by sending the signal of the braking force calculation section Ml1 to another control unit via the intra-braking controller communication 42 while utilizing the driver control section M13 provided to the master controller 50A. On the other hand, when the master controller is not unitized with the electric brake, the driver control section that is provided to the master controller cannot be utilized. That is, as described above, the intra-braking controller communication 42 cannot send the signal in a faster cycle than the calculation cycle of the driver control section M13. Thus, when the front wheel has a redundant configuration similar to this embodiment, the slave microcomputer has to be added to each of the front wheel control units, each of which is unitized with the electric brake, and the number of the microcomputers as the brake system is increased by two. Even in the case where the master controller is not unitized with the electric brake, the driver control section that is provided to the master controller can be utilized. However, in this case, a physical distance between the driver and the electric motor is increased. That is, the signal from the driver control section M13 to the driver cannot be exchanged via the intra-braking controller communication 42. Thus, when the driver control section M13 is utilized, the driver control section M13 and the driver have to be in close physical arrangement. This results in disadvantages including increased cost of a wire harness, which is caused by extension of a path between the driver and the electric motor, through which the large current flows, and reduced driving efficiency of the electric motor caused by increased wiring resistance. Thus, the configuration in this embodiment is advantageous.

In addition, in this embodiment, the left front wheel control unit 41A and the right front wheel control unit 41B have the same configuration, and the left rear wheel control unit 41C and the right rear wheel control unit 41D have the same configuration. Thus, the common units can be used, and the further inexpensive brake system can be acquired.

### Modified Examples

The above embodiment can be modified and implemented as follows. The above embodiment and the following modified examples can be implemented in combination with each other unless being technically contradictory.
An electric motor having a single wire is adopted as the electric motor that is provided to each of the front-wheel electric brakes 20A, 20B, and the control units 41A, 41B for the front wheels are each configured to have only the slave controller among the master controller and the slave controller. In this case, the double-winding motor is adopted as the electric motor that is provided to each of the rear-wheel electric brakes 20C, 20D, and the control units 41C, 41D for the rear wheels are each configured to include both the master controller and the slave controller.

In the case of this modified example, the left rear wheel RL corresponds to the first wheel, the right rear wheel RR corresponds to the second wheel, the left front wheel FL corresponds to the third wheel, and the right front wheel FR corresponds to the fourth wheel. In addition, the electric motor of the electric brake 200 for the left rear wheel corresponds to the first electric actuator, the electric motor of the electric brake 20D for the right rear wheel corresponds to the second electric actuator, the electric motor of the electric brake 20A for the left front wheel corresponds to the third electric actuator, and the electric motor of the electric brake 20B for the right front wheel corresponds to the fourth electric actuator. Then, the master controller of the left rear wheel control unit, the slave controller of the right rear wheel control unit, and the slave controller of the left front wheel control unit constitute the first controller group. The master controller of the right rear wheel control unit, the slave controller of the left rear wheel control unit, and the slave controller of the right front wheel control unit constitute the second controller group. In this case, the master controller of the left rear wheel control unit corresponds to the first regulation controller, and the slave controller of the left rear wheel control unit corresponds to the second regulation controller. Furthermore, the slave controller of the right rear wheel control unit corresponds to the third regulation controller, and the master controller of the right rear wheel control unit corresponds to the fourth regulation controller.

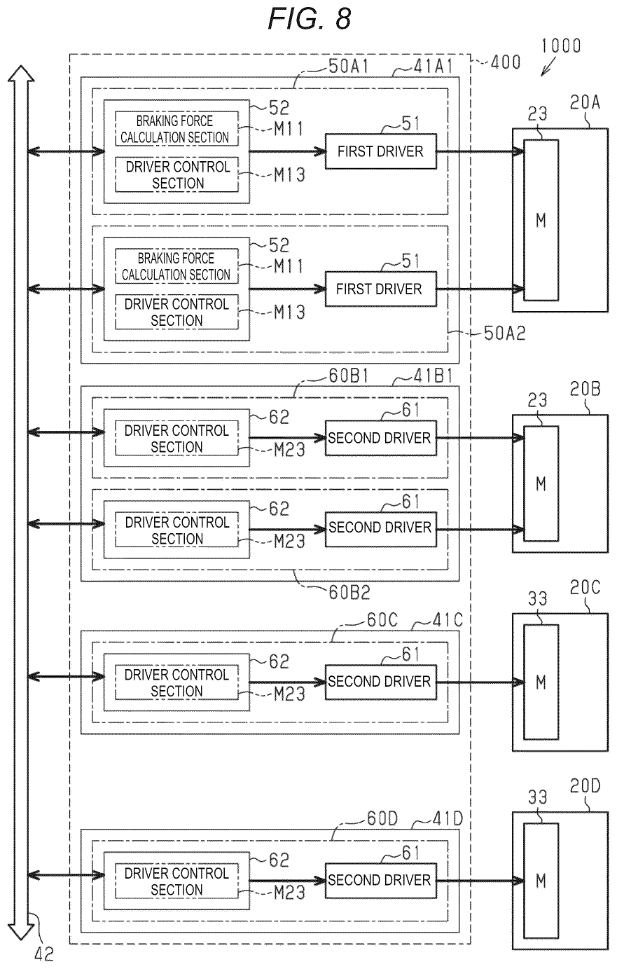

With such a configuration, even when the power supply from one of the first power source 11 and the second power source 12 to the brake system is stopped, the braking force can be generated on the three wheels. Furthermore, even when the power supply from the first power source 11 among the first power source 11 and the second power source 12 is stopped, or even when the power supply from the second power source 12 is stopped, the braking force can be generated on the two rear wheels RL, RR.
The electric motor that is controlled by the control unit provided with both the master controller and the slave controller may not be the double-winding motor. In this case, the switching circuit for switching the controller for controlling the driver between the master controller and the slave controller may be provided to the control unit. With this configuration, when the operation of one controller of the master controller and the slave controller is stopped, the switching circuit is actuated to actuate the driver by the other controller, and the electric motor can thereby be driven.
As the brake system, a brake system 1000 illustrated in FIG. 8 can also be adopted.

A description will be made on a braking controller 400 of the brake system 1000 with reference to FIG. 8. The braking controller 400 includes a left front wheel control unit 41A1, a right front wheel control unit 41B1, the left rear wheel control unit 41C, and the right rear wheel control unit 41D. The left front wheel control unit 41A1 has a master controller 50A1 and a master controller 50A2. The plural master controllers 50A1, 50A2 each have the first driver 51 and the master microcomputer 52. Of the two wires of the electric motor 23 in the electric brake 20A for the left front wheel, the first driver 51 of the master controller 50A1 is electrically connected to the first wire, and the first driver 51 of the master controller 50A2 is electrically connected to the second wire.

The right front wheel control unit 41B1 has a slave controller 60B1 and a slave controller 60B2. These two slave controllers 60B1, 60B2 each have the second driver 61 and the slave microcomputer 62. Of the two wires of the electric motor 23 in the electric brake 20B for the right front wheel, the second driver 61 of the slave controller 60B1 is electrically connected to the first wire, and the second driver 61 of the slave controller 60B2 is electrically connected to the second wire.

In the braking controller 400, the master controller 50A1 and the slave controller 60B1 are classified into the first controller group, and the master controller 50A2 and the slave controller 60B2 are classified into the second controller group. In this case, the master controller 50A1 of the first controller group corresponds to the “first regulation controller”, and the master controller 50A2 of the second controller group corresponds to the “second regulation controller”. In addition, the slave controller 60B1 of the first controller group corresponds to the “third regulation controller”, and the slave controller 60B2 of the second controller group corresponds to the “fourth regulation controller”. Therefore, in the brake system 1000, even when the power supply from the first power source 11 is stopped, or even when the power supply from the second power source 12 is stopped, the braking force can be generated on the three wheels.

In addition, as a further different configuration from that in FIG. 8, the left rear wheel control unit may have a master controller, the right rear wheel control unit may have a master controller, the left front wheel control unit may have a first slave controller and a second slave controller, and the right front wheel control unit may have a first slave controller and a second slave controller. Also, in the brake system 1000 having this configuration, even when the power supply from the first power source 11 is stopped, or even when the power supply from the second power source 12 is stopped, the braking force can be generated on the three wheels. In this configuration, since the master controllers are arranged in a rear portion of the vehicle, it is possible to reduce occurrence of such an event that both of the two master controllers fail due to an impact against a front portion of the vehicle, and to use the common units.

Similarly, one each of the master controllers may be arranged in the front wheel control unit and the rear wheel control unit. In this arrangement, it is possible to reduce occurrence of such an event that both of the two master controllers fail due to the impact against the front portion of the vehicle and the impact against the rear portion of the vehicle.
Only when the master controller 50B cannot calculate the commanded braking force, the master controller 50A may calculate the commanded braking force FbB for the right front wheel FR and the commanded braking force FbC for the left rear wheel RL. A case where the master controller 50B cannot calculate the commanded braking force includes a case where the power supply to the master controller 50B is stopped and a case where abnormality such as the failure occurs to the master controller 50B.

Similarly, only when the master controller 50A cannot calculate the commanded braking force, the master controller 50B may calculate the commanded braking force FbA for the left front wheel FL and the commanded braking force FbD for the right rear wheel RR. A case where the master controller 50A cannot calculate the commanded braking force includes a case where the power supply to the master controller 50A is stopped and a case where the abnormality such as the failure occurs to the master controller 50A.
When the brake system 100 is normal, each of the left rear wheel control unit 41C and the right rear wheel control unit 41D may actuate the second driver 61 on the basis of the commanded braking force that is calculated by the master controller 50A. Alternatively, each of the left rear wheel control unit 41C and the right rear wheel control unit 41D may actuate the second driver 61 on the basis of the commanded braking force that is calculated by the master controller 50B.
The electric actuator may be an actuator other than the electric motor as long as the electric brake can generate the braking force on the wheel by driving of the electric actuator.
The electric brake may not be the dry electric brake as illustrated in FIG. 1 as long as the brake can generate the braking force, which corresponds to a drive amount of the electric actuator, on the wheel. For example, the electric brake may be a wet electric brake that has the electric motor as a power source and includes an electric cylinder. In addition, for example, of the plural electric brakes, the dry electric brake may be adopted as one or more of the electric brakes, and the wet electric brake may be adopted as the rest of the electric brakes.
In the above embodiment, the description has been made on the case where the vehicle has the four wheels. However, the number of the wheels is not limited to four. For example, when the number of the wheels is six, additional two wheels may each be provided with a brake unit in which a control unit having the same configuration as the rear wheel control unit and an electric brake having the same configuration as the rear-wheel electric brake are unitized. At this time, the power is preferably supplied to the brake units of the additional two wheels from mutually different power sources. With such a configuration, even when one of the power sources fails, the braking forces on the four wheels of the six wheels can be guaranteed.
The microcomputer can be configured as one or more processors, each of which is operated according to a computer program, one or more dedicated hardware circuits, such as dedicated hardware, that execute at least some of various types of processing, or a circuit that includes a combination of these. An example of the dedicated hardware can be an ASIC that is an application-specific integrated circuit. The processor includes a CPU and memory such as RAM and ROM, and the memory stores a program code or a command that is configured to cause the CPU to execute the processing. The memory, that is, a storage medium includes any available medium that can be accessed by a general-purpose or dedicated computer.

The expression “at least one” as used in the present regulation means “one or more” of desired options. As an example, the expression “at least one” as used in the present regulation means “only one option” or “both of two options” when the number of the options is two. As another example, the expression “at least one” as used in the present regulation means “only one option” or “any combination of two or more options” when the number of the options is three or more.

### Other Technical Ideas

Technical ideas that can be comprehended from the embodiment and the modified examples described above will be described as supplementary notes.

[Supplementary Note 1] Preferably, the first electric actuator and the second electric actuator are driven to generate the braking force on the left and right front wheels of the vehicle, respectively.

[Supplementary Note 2] Preferably, the first electric actuator is an actuator that is driven to generate the braking force on the first wheel,
the second electric actuator is an actuator that is driven to generate the braking force on the second wheel,
the third electric actuator is an actuator that is driven to generate the braking force on the third wheel,
the fourth electric actuator is an actuator that is driven to generate the braking force on the fourth wheel,
the first regulation controller is the first master controller, and
the third regulation controller is the second master controller.

[Supplementary Note 3] Preferably, the braking force calculation section of the first master controller
calculates the braking force to be generated on the first wheel by driving of the first electric actuator, and
calculates the braking force to be generated on the fourth wheel by driving of the fourth electric actuator.

[Supplementary Note 4] Preferably, the braking force calculation section of the second master controller
calculates the braking force to be generated on the second wheel by driving of the second electric actuator, and
calculates the braking force to be generated on the third wheel by driving of the third electric actuator.

[Supplementary Note 5] Preferably, the second regulation controller is the third slave controller, and
the fourth regulation controller is the first slave controller.

1. A brake system that is applied to a vehicle including a first power source and a second power source that differs from the first power source, the brake system comprising:
a first electric actuator to a fourth electric actuator that respectively generate a braking force on a first wheel to a fourth wheel of the vehicle;
plural master controllers, each of which includes a driver that adjusts power supplied to any one of the first electric actuator to the fourth electric actuator, a braking force calculation section that calculates the braking force to be generated on the first wheel to the fourth wheel by driving of the first electric actuator to the fourth electric actuator, and a driver control section that actuates the driver according to a calculation result by the braking force calculation section; and
plural slave controllers, each of which includes a driver that adjusts the power supplied to any one of the first electric actuator to the fourth electric actuator, and a driver control section that actuates the driver according to the calculation result by the braking force calculation section of the master controller, wherein
a first master controller of the plural master controllers and a first slave controller and a second slave controller of the plural slave controllers constitute a first controller group that is not supplied with the power from the second power source but is supplied with the power from the first power source,
a second master controller of the plural master controllers and a third slave controller and a fourth slave controller of the plural slave controllers constitute a second controller group that is not supplied with the power from the first power source but is supplied with the power from the second power source,
both of a first regulation controller of the first controller group and a second regulation controller of the second controller group control the first electric actuator,
both of a third regulation controller, which differs from the first regulation controller, of the first controller group and a fourth regulation controller, which differs from the second regulation controller, of the second controller group control the second electric actuator,
of the first controller group, a controller that differs from the first regulation controller and the third regulation controller controls the third electric actuator, and
of the second controller group, a controller that differs from the second regulation controller and the fourth regulation controller controls the fourth electric actuator.

2. The brake system according to claim 1, wherein
the first electric actuator is a double-winding motor in which a wire that is electrically connected to the driver of the first regulation controller and a wire that is electrically connected to the driver of the second regulation controller are provided separately, and
the second electric actuator is a double-winding motor in which a wire that is electrically connected to the driver of the third regulation controller and a wire that is electrically connected to the driver of the fourth regulation controller are provided separately.

3. The brake system according to claim 2, wherein at least one of the first master controller and the second master controller is unitized with any of the first electric actuator to the fourth electric actuator.

4. The brake system according to claim 1, wherein at least one of the first master controller and the second master controller is unitized with any of the first electric actuator to the fourth electric actuator.
